(19) United States
(12) Patent Application Publication
(10) Pub. No.: US 2016/0306063 A1
(43) Pub. Date: Oct. 20, 2016

(54) SYNTHETIC APERTURE RADAR MINERAL PROSPECTOR

(71) Applicant: ELWHA LLC, Bellevue, WA (US)

(72) Inventors: Roderick A. Hyde, Redmond, WA (US); Jordin T. Kare, San Jose, CA (US); Nathan P. Myhrvold, Medina, WA (US); Clarence T. Tegreene, Mercer Island, WA (US); Charles Whitmer, North Bend, WA (US); Lowell L. Wood, JR., Bellevue, WA (US)

(73) Assignee: ELWHA LLC, Bellevue, WA (US)

(21) Appl. No.: 14/689,895

(22) Filed: Apr. 17, 2015

(51) Int. Cl. G01V 3/12; G01S 7/41; G01S 13/00; G01S 13/88; G01S 13/90

(52) U.S. Cl. CPC G01V 3/12; G01S 13/885; G01S 13/90; G01S 13/003; G01S 7/412

(57) ABSTRACT

A method for detecting underground natural resources using synthetic aperture radar includes providing a ground-penetrating phase-coherent radar system incorporating a moving platform; sending a plurality of radar signals from a plurality of points along a plurality of paths through an underground volume, the plurality of radar signals producing a plurality of radar returns; collecting the plurality of radar returns along the plurality of paths with the ground-penetrating phase-coherent radar system; coherently processing the plurality of radar returns with a processing circuit to determine a characteristic of a sub-surface feature; retrieving information relating to a reference underground volume from a memory; and identifying a potential sub-surface resource by using the processing circuit to compare the characteristic of the sub-surface feature with the information relating to the reference underground volume.

### BACKGROUND

Mining operations often remove and refine aggregate ore from remote locations. This removal and refinement process requires moving heavy machinery and ore processing equipment to the remote location. Moving heavy equipment is costly, labor intensive, time consuming, and can adversely affect the environment. In order to promote efficiency while protecting the environment, mining operations first explore an area to determine the potential for an amount of aggregate ore present.

A traditional method for exploring an area of land includes sample drilling. This sample drilling technique may include drilling an array of holes and determining the amount of aggregate ore within each sample. From this array of samples, prospectors can determine what may be potentially efficient locations to place the heavy machinery and ore processing equipment. However, drilling an array of holes requires moving the drilling equipment through the mining area and physically removing a ground sample. This process may be harmful to the environment, labor intensive, and provide relatively course results.

Other traditional methods for exploring an area of land include taking ground conductivity measurements and using surface-level ground penetrating radar. Ground conductivity measurements may be taken from an aerial vehicle by driving a coil into the ground and measuring the response to a low frequency output. This measurement technique may be complicated by variations within the ground water content. Surface-level ground penetrating radar involves searching for aggregate ore by moving a radar device over an area at ground level. These systems often include a narrow sweep angle such that the radar device must pass directly over an area of interest to locate aggregate ore. These traditional systems are labor intensive and may not accurately identify or locate an aggregate ore sample.

### SUMMARY

One embodiment relates to a method for detecting underground natural resources using synthetic aperture radar. The method includes providing a ground-penetrating phase-coherent radar system incorporating a moving platform; sending a plurality of radar signals from a plurality of points along a plurality of paths through an underground volume, the plurality of radar signals producing a plurality of radar returns; collecting the plurality of radar returns along the plurality of paths with the ground-penetrating phase-coherent radar system; coherently processing the plurality of radar returns with a processing circuit to determine a characteristic of a sub-surface feature; retrieving information relating to a reference underground volume from a memory; and identifying a potential sub-surface resource by using the processing circuit to compare the characteristic of the sub-surface feature with the information relating to the reference underground volume.

Another embodiment relates to a method for detecting underground natural resources using synthetic aperture radar. The method includes providing a ground-penetrating phase-coherent radar system incorporating a moving platform; sending a plurality of radar signals from a plurality of points along a plurality of paths through an underground volume, the plurality of radar signals producing a plurality of radar returns; collecting the plurality of radar returns along the plurality of paths with the ground-penetrating phase-coherent radar system; coherently processing the plurality of radar returns with a processing circuit to produce data relating to a characteristic of a sub-surface feature; retrieving a database of values relating to sub-surface resources from a memory; and identifying a potential sub-surface resource by using the processing circuit to compare the data relating to the characteristic of the sub-surface feature with the database of values.

Still another embodiment relates to a method for experimentally generating a reference associated with underground natural resources using synthetic aperture radar. The method includes providing a ground-penetrating phase-coherent radar system incorporating a moving platform; sending a plurality of radar signals from a plurality of points along a plurality of paths through an underground volume containing a known sub-surface resource, the plurality of radar signals producing a plurality of radar returns; collecting the plurality of radar returns along the plurality of paths with the ground-penetrating phase-coherent radar system; coherently processing the plurality of radar returns with a processing circuit to produce processed data values; and generating at least one of a reference underground volume and a database of the processed data values relating an identity of the known sub-surface resource with a characteristic of the known sub-surface resource.

Still another embodiment relates to a system for detecting underground natural resources using synthetic aperture radar. The system includes a ground-penetrating phase-coherent radar system and a processing circuit. The ground-penetrating phase-coherent radar system includes a transmitter, a receiver, and a moving platform. The transmitter is configured to send a plurality of radar signals from a plurality of points along a plurality of paths through an underground volume. The plurality of radar signals produce a plurality of radar returns. The receiver is configured to engage the plurality of radar returns. The ground-penetrating phase-coherent radar system is configured to collect the plurality of radar returns along the plurality of paths. The processing circuit includes a memory and is coupled to the ground-penetrating phase-coherent radar system. The processing circuit is configured to coherently process the plurality of radar returns to determine a characteristic of a sub-surface feature, retrieve information relating to a reference underground volume from the memory, and identify a potential sub-surface resource by comparing the characteristic of the sub-surface feature with the information relating to the reference underground volume.

Still another embodiment relates to a system for detecting underground natural resources using synthetic aperture radar. The system includes a ground-penetrating phase-coherent radar system and a processing circuit. The ground-penetrating phase-coherent radar system includes a transmitter, a receiver, and a moving platform. The transmitter is configured to send a plurality of radar signals from a plurality of points along a plurality of paths through an underground volume. The plurality of radar signals produce a plurality of radar returns. The receiver is configured to engage the plurality of radar returns. The ground-penetrating phase-coherent radar system is configured to collect the plurality of radar returns along the plurality of paths. The processing circuit includes a memory and is coupled to the ground-penetrating phase-coherent radar system. The processing circuit is configured to coherently process the plurality of radar returns to produce data relating to a characteristic of a sub-surface feature, retrieve a database of values relating to sub-surface resources from the memory, and identify a potential sub-surface resource by comparing the data relating to the characteristic of the sub-surface feature with the database of values.

Still another embodiment relates to a system for experimentally generating a reference associated with underground natural resources. The system includes a ground-penetrating phase-coherent radar system and a processing circuit. The ground-penetrating phase-coherent radar system includes a transmitter, a receiver, and a moving platform. The transmitter is configured to send a plurality of radar signals from a plurality of points along a plurality of paths through an underground volume containing a known sub-surface resource. The plurality of radar signals produce a plurality of radar returns. The receiver is configured to engage the plurality of radar returns. The ground-penetrating phase-coherent radar system is configured to collect the plurality of radar returns along the plurality of paths. The processing circuit is coupled to the ground-penetrating phase-coherent radar system and configured to coherently process the plurality of radar returns to produce processed data values, and generate at least one of a reference underground volume and a database of the processed data values relating an identity of the known sub-surface resource with a characteristic of the known sub-surface resource.

The invention is capable of other embodiments and of being carried out in various ways. Alternative exemplary embodiments relate to other features and combinations of features as may be generally recited in the claims.

### BRIEF DESCRIPTION OF THE FIGURES

The invention will become more fully understood from the following detailed description taken in conjunction with the accompanying drawings wherein like reference numerals refer to like elements, in which:

FIG. 1 is an elevation view of a mineral prospector located above an aggregate ore sample.

FIG. 2 is an elevation view of a mineral prospector located above an aggregate ore sample surrounded by secondary materials and a layer of overburden.

FIG. 3 is an elevation view of a mineral prospector utilizing radar to locate an aggregate ore sample.

FIG. 4 is an elevation view of a mineral prospector utilizing radar to locate an aggregate ore sample.

FIG. 5 is an elevation view of a mineral prospector utilizing radar to locate an aggregate ore sample.

FIG. 6 is an elevation view of waves emitted by a mineral prospector and scattered off the ground surface and the aggregate ore deposit.

FIG. 7 is a graph showing an electromagnetic wave emitted by a mineral prospector.

FIG. 8 is a graph showing an electromagnetic wave emitted by a mineral prospector.

FIG. 9 is an elevation view of a mineral prospector having a generator and a processor.

FIG. 10 is a schematic view of a mineral prospector having a processor configured to transmit data to a central location.

FIG. 11 is a schematic view of a mineral prospector having a processor configured to transmit data to a user interface.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Mineral prospecting using synthetic aperture radar (“SAR”) is intended to provide an efficient alternative to traditional exploration techniques. Such equipment utilizes a synthetic aperture system to scan an area. Such scanning may occur without physical contact between the scanning system and the ground surface. This lack of contact limits the environmental impact of the exploration process and reduces the labor required to locate a potential aggregate ore deposit.

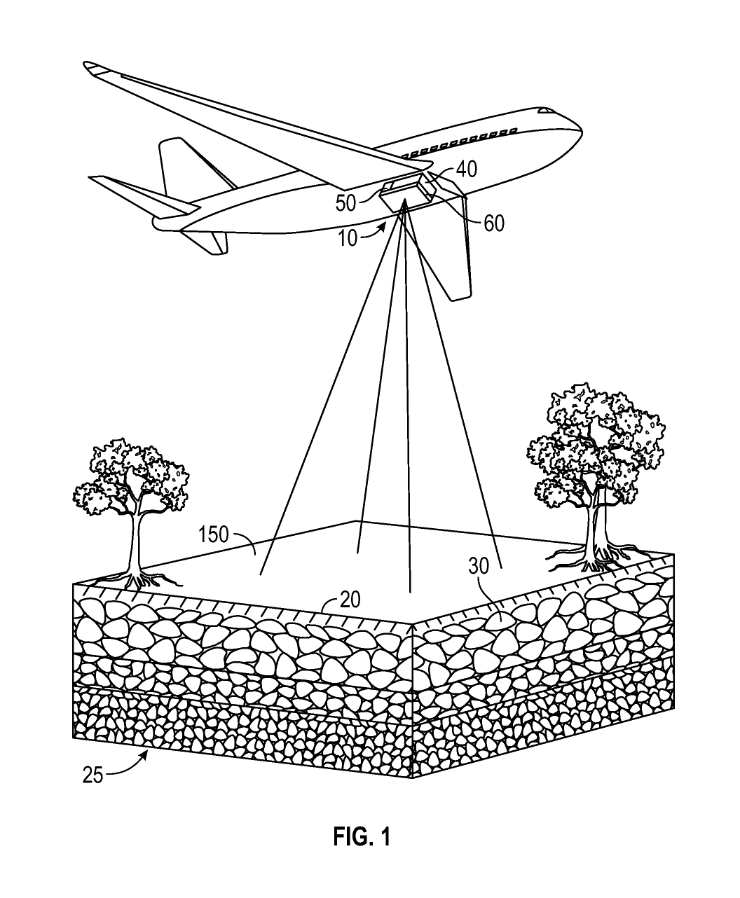

Referring FIG. 1, a radar locator is shown as mineral prospector 10, according to an exemplary embodiment. Mineral prospector 10 may be a radar system that uses coherent aperture synthesis to explore an area. According to an exemplary embodiment, mineral prospector 10 is coupled to a vehicle. In one embodiment, the vehicle is an airplane. In other embodiments, the vehicle is another type of vehicle (e.g., a helicopter, a blimp, an aerial drone, a car, a truck, a crane, a watercraft, etc.). As shown in FIG. 1, mineral prospector 10 is located above a fluid-ground interface, shown as base level 20. Base level 20 may be the interface between a fluid and a soil volume, shown as subterranean ground volume 25. Subterranean ground volume 25 may have an electrical and magnetic conductivity and include a variety of materials such as a primary material, shown as target material 30. According to an exemplary embodiment, target material 30 may have an electrical conductivity greater than the electrical conductivity of subterranean ground volume 25. Mineral prospector 10 may detect target material 30 within subterranean ground volume 25 in the form of small particles, veins, or sheets, among other orientations, by comparing the relative conductivities of subterranean ground volume 25 and target material 30.

According to the exemplary embodiment shown in FIG. 1, mineral prospector 10 may interact with target material 30 to differentiate between target material 30 and subterranean ground volume 25. According to an exemplary embodiment, target material 30 may be any metal ordinarily mined. By way of example, target material 30 may be gold, silver, iron, any other metal, or ores containing such metals. According to the exemplary embodiment shown in FIG. 1, target material 30 is gold having an identified conductivity. By way of example, such an identified conductivity value of gold at twenty degrees Celsius may be approximately 4.10×10⁷ S/m (Siemens per meter). According to an alternative embodiment, target material 30 may be various alternative substances including, among other materials, nonmetallic ores, oil, and water.

Referring still to the exemplary embodiment shown in FIG. 1, mineral prospector 10 may further include a structure, shown as support 40. Support 40 may be manufactured from any known material sufficient to support the weight of the various components of mineral prospector 10 (e.g., aluminum, titanium, etc.). Support 40 may be a rigid structure capable of maintaining the spacing between the components of mineral prospector 10. Such rigid structure may include a plurality of cross braces or may include components manufactured using processes designed to control stress transfer through support 40 (e.g., forging, etc.).

Referring still to the exemplary embodiment shown in FIG. 1, mineral prospector 10 may further include a wave producer, shown as propagator 50. As shown in FIG. 1, propagator 50 may be coupled to support 40. Propagator 50 may be any device capable of producing electromagnetic waves. Propagator 50 may be passed over an area of interest, shown as prospecting zone 150, in order to scan prospecting zone 150 for target material 30. Such a scan may involve one pass or multiple passes over prospecting zone 150. According to an exemplary embodiment, propagator 50 may be located at least 20 meters above base level 20. According to an alternative embodiment, propagator 50 may be located less than 20 meters above base level 20. The height of propagator 50 above base level 20 may affect the ability of mineral prospector 10 to locate target material 30 within subterranean ground volume 25. According to still another alternative embodiment, the height of propagator 50 may be varied with respect to base level 20 in order to provide numerous sets of data for each area within prospecting zone 150.

Referring still to the exemplary embodiment shown in FIG. 1, mineral prospector 10 may further include a wave handling device, shown as transceiver 60. As shown in FIG. 1, transceiver 60 may be a bar shaped device coupled with support 40 and propagator 50. According to an exemplary embodiment, transceiver 60 may further include an internal structure that converts an electrical signal into an electromagnetic wave or an electromagnetic wave into an electrical signal. According to an exemplary embodiment, transceiver 60 is configured to receive an electrical signal from propagator 50 and emit a corresponding electromagnetic wave.

According to an exemplary embodiment, mineral prospector 10 is a monostatic design having a single transceiver 60 configured to receive and transmit electromagnetic waves. According to an alternative embodiment, mineral prospector 10 is a bistatic design having two transceivers 60. Such a design includes one transceiver 60 configured to receive and transmit electromagnetic radiation and a second transceiver 60 is configured only to receive electromagnetic radiation. According to still another alternative embodiment, mineral prospector 10 is a multistatic design having three or more transceivers 60. Such a design includes one transceiver 60 configured to receive and transmit electromagnetic waves and additional transceivers 60 configured only to receive electromagnetic radiation.

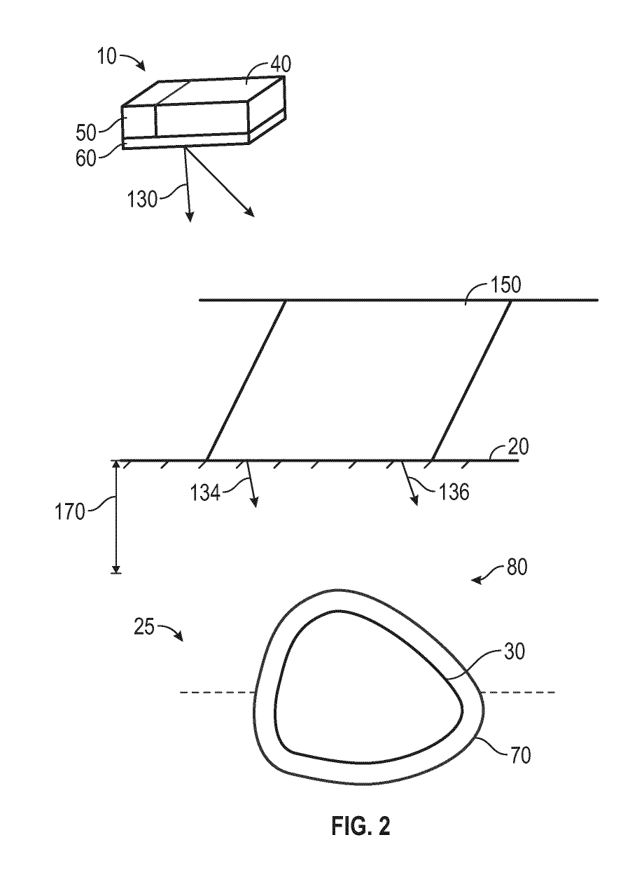

Referring next to the alternative embodiment shown in FIG. 2, mineral prospector 10 may further interact with various layers within subterranean ground volume 25. Such layers may include a layer surrounding target material 30, shown as aggregate 70 and a layer of soil and rock that must be removed to extract target material 30, shown as earth 80. Aggregate 70 and earth 80 may be uniform in composition or may include a variety of materials either layered or dispersed within aggregate 70 and earth 80. Aggregate 70 and earth 80 may be any material commonly found in mining environments (e.g., rock, sand, clay, etc.). According to an exemplary embodiment, the materials within aggregate 70 and earth 80 may be dielectric materials having an electrical and magnetic conductivity. The electrical or magnetic conductivity of materials within aggregate 70 and earth 80 may be lower than the target material 30. According to an alternative embodiment, the electrical or magnetic conductivity of materials within aggregate 70 and earth 80 may be greater than target material 30.

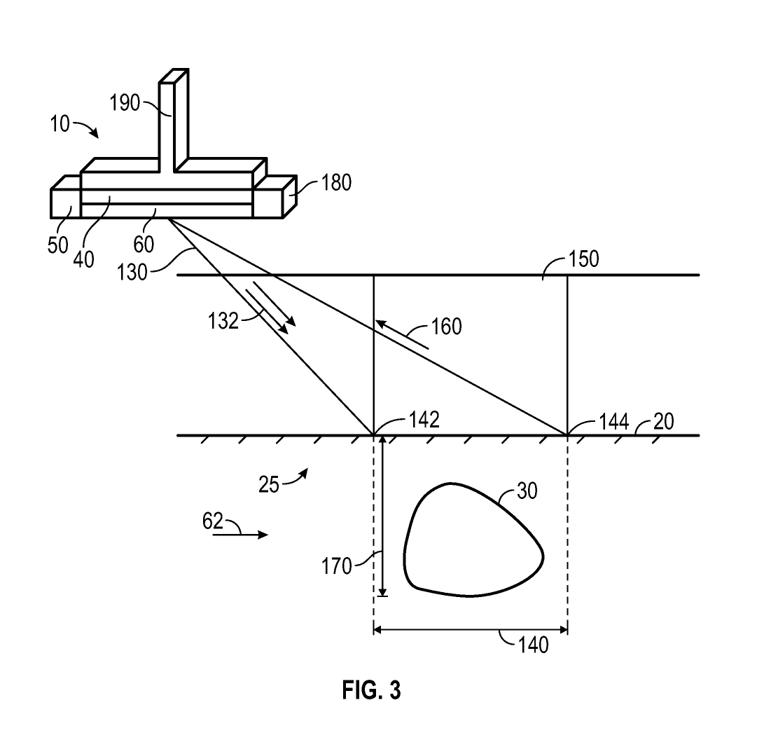

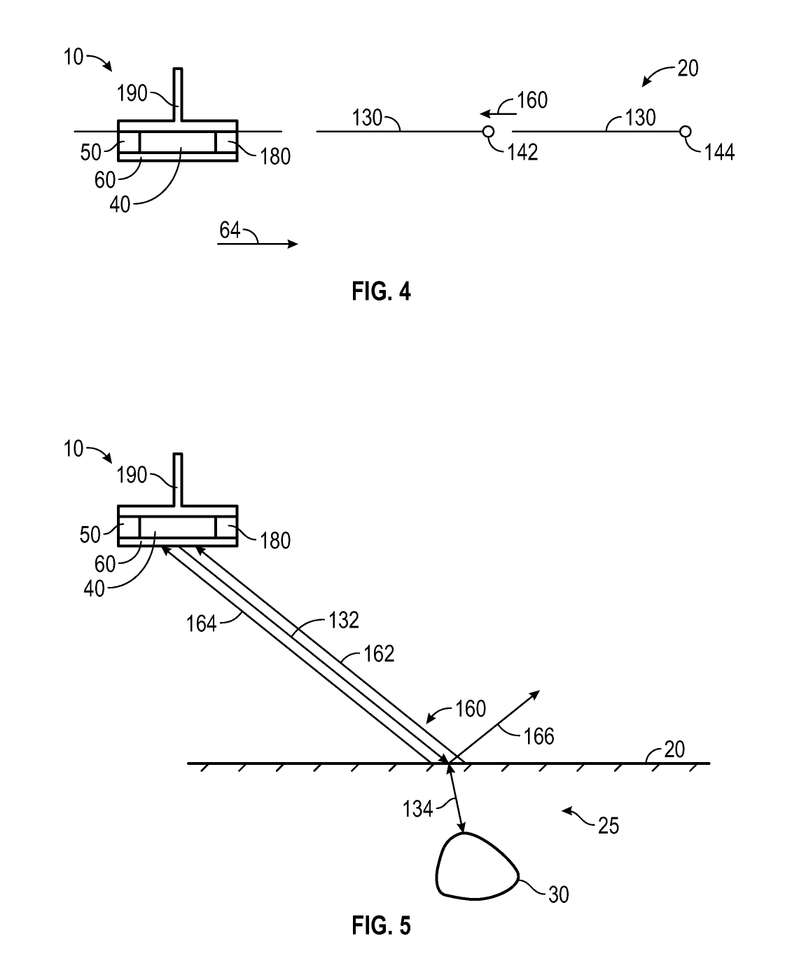

Referring next to the exemplary embodiment shown in FIGS. 3-4, mineral prospector 10 includes support 40, propagator 50, and transceiver 60. As shown in FIGS. 3-4, mineral prospector 10 may be coupled with a motive device, shown as carrier 190. According to the exemplary embodiment shown in FIGS. 3-4, carrier 190 may be a vehicle configured to move mineral prospector 10 with respect to base level 20. According to an exemplary embodiment, carrier 190 moves mineral prospector 10 within 10 meters above base level 20. According to an alternative embodiment, carrier 190 moves mineral prospector 10 more than 10 meters above base level 20. Such movement above base level 20 may occur by carrier 190 transporting mineral prospector 10 through or above a fluid located above base level 20. According to an exemplary embodiment, the fluid located above base level 20 is air and carrier 190 moves mineral prospector 10 through the air. According to an alternative embodiment, the fluid located above base level 20 is a liquid and carrier 190 moves mineral prospector 10 along an upper surface of the liquid. Such movement may facilitate the scanning operation of mineral prospector 10 or may facilitate transport of mineral prospector 10 from one location to another. As shown in FIG. 3, carrier 190 moves mineral prospector 10 with respect to base level 20 to scan prospecting zone 150 more effectively.

Referring still to the exemplary embodiment shown in FIGS. 3-4, carrier 190 may include any known type of vehicle. According to an exemplary embodiment, carrier 190 may comprise an aircraft (e.g., helicopter, plane, unmanned aerial vehicle, balloon, etc.). According to various alternative embodiments, carrier 190 may comprise a spacecraft (e.g., satellite, a manned space capsule, etc.), a water vehicle (e.g., hovercraft, boat, buoy, etc.), or a ground vehicle (e.g., truck, autonomous transport, etc.). According to an exemplary embodiment, the movement of carrier 190 is controlled to efficiently scan prospecting zone 150. By way of example, such efficient movement may involve a single pass or may involve retracing a previously traveled route. By way of another example, such efficient movement may involve a plurality of passes (i.e., multiple paths taken, etc.). In one embodiment, the plurality of paths include a plurality of parallel lines. In another embodiment, the plurality of paths include a plurality of intersecting lines that are skewed relative to one another. In other embodiments, the plurality of paths include a plurality of arcs and/or a plurality of circles. The plurality of paths may be uniformly spaced or non-uniformly spaced. According to an alternative embodiment, a route for most efficiently scanning prospecting zone 150 may not be practical given that the movement of carrier 190 may be limited by various obstacles (e.g., geographical terrain, atmospheric conditions, vegetation, foreign objects, etc.). These obstacles may require an alternate path that allows carrier 190 to safely transport mineral prospector 10 and allow for a practical scan path for prospecting zone 150 given the presence of various obstacles.

By way of example, carrier 190 may be a ground vehicle that operates along the most efficient path where the surrounding terrain permits (e.g., desert, ice sheet, where cutting roads is practical, etc.). Where the surrounding terrain does not permit movement along the most efficient path, carrier 190 may operate along existing roads or travel routes (e.g., extremely rocky terrain, uninhabitable environments, dense jungle environment, etc.). During such operation, the vehicle may be operated along an existing road or travel route, and the elevation of transceiver 60 may be increased or decreased as necessary to allow mineral prospector 10 to effectively scan prospecting zone 150 to obtain one or more data sets. According to an exemplary embodiment, carrier 190 may further include a crane system to allow for still greater height variation of transceiver 60.

Referring still to the exemplary embodiment shown in FIG. 3, mineral prospector 10 may utilize electromagnetic waves to scan prospecting zone 150. According to an exemplary embodiment, propagator 50 may be coupled to transceiver 60 and may provide transceiver 60 with generated electromagnetic wave signals. Transceiver 60 may receive generated electromagnetic wave signals from propagator 50 and release an electromagnetic scanning ray, shown as emitted beam 130 toward base level 20. As shown in FIG. 3, emitted beam 130 includes outer beam limit 144 and inner beam limit 142. Emitted beam 130 may further include swath 140 defined by the lateral distance between outer beam limit 144 and inner beam limit 142. Swath 140 may be an effective sweep path of mineral prospector 10 along base level 20 within prospecting zone 150.

According to the exemplary embodiment shown in FIGS. 3-4, emitted beam 130 extends outwardly from mineral prospector 10. As shown in FIG. 3, emitted beam 130 extends outward from mineral prospector 10 along range direction 62. As shown in FIG. 4, mineral prospector 10 may travel along azimuth direction 64. According to an exemplary embodiment, emitted beam 130 projects downward from mineral prospector 10 toward base level 20. According to an alternative embodiment, emitted beam 130 may extend upward, in front of, behind, or generally to the side of mineral prospector 10, among other directions.

According to the exemplary embodiment shown in FIG. 3, emitted beam 130 may include a plurality of waves 132. Emitted beam 130 may release a single wave 132 or may release a plurality of waves 132. According to an exemplary embodiment, waves 132 may include specified characteristics that affect various performance features of mineral prospector 10. Such performance features of mineral prospector 10 may include swath 140 and the effectiveness of mineral prospector 10 in locating target material 30, among other features.

According to an exemplary embodiment, a specified characteristic of waves 132 may be frequency. As discussed above, the frequency of waves 132 affects various performance features of mineral prospector 10. By way of example, the frequency of waves 132 may affect the way waves 132 interact with aggregate 70, earth 80, and target material 30. According to an exemplary embodiment, waves 132 may have a lower frequency and travel further into aggregate 70, earth 80, and target material 30 than waves 132 having a higher frequency. Such additional distance may affect the ability of mineral prospector 10 to scan prospecting zone 150 effectively. The frequency of waves 132 may further affect the quality or clarity of a produced image of mineral prospector 10. The produced image may be a two-dimensional image or a three dimensional image. According to various alternative embodiments, the specified characteristic of waves 132 may be intensity, release angle, and polarization, among other known features of electromagnetic waves.

Referring next to the exemplary embodiment shown in FIG. 5, emitted beam 130 may include wave 132 that interacts with base level 20 and target material 30 to produce a reflected ray, shown as scattered beam 160. As shown in FIG. 5, scattered beam 160 may include surface back scattered waves 164, surface side scattered waves 166, and contacting scattered waves 162. According to an exemplary embodiment, base level 20 may be vegetation, a silica material, or other known materials that scatter electromagnetic wave materials that transmit waves, and materials that reflect waves. When wave 132 interacts with base level 20, at least a portion of the energy is scattered back towards mineral prospector 10 as surface back scattered waves 164.

As shown in FIG. 5, wave 132 interacts with base level 20 and also may reflect a portion of the energy from wave 132 at a variety of angles in the form of surface side scattered wave 166. The remaining energy from wave 132 is transmitted through base level 20. As shown in FIG. 5, such transmitted energy may travel as contacting wave 134 and interact with target material 30. According to an exemplary embodiment, contacting wave 134 may travel at an angle relative to wave 132 due to a difference between the refractive index of a fluid above base level 20 and the refractive index of subterranean ground volume 25. Upon interacting with target material 30, at least a portion of the energy from contacting wave 134 is scattered back along the initial path of contacting wave 134 and towards mineral prospector 10 as contacting scattered wave 162.

In an exemplary embodiment, mineral prospector 10 emits a plurality of waves across an emitted beam and receive a plurality of contacting waves, back scattered waves, and side scattered waves. Mineral prospector 10 may then compile various features (e.g., timing data, frequency, intensity, etc.) of the received waves together to determine the lateral distance between the ground level impact point of the emitted waves and transceiver. Mineral prospector 10 may further compare information (e.g., timing data, frequency, intensity, etc.) from backscattered waves and contacting waves to determine the depth or presence of a target material. According to an exemplary embodiment, transceiver 60 may transmit an emitted beam as mineral prospector 10 is moved with respect to the ground. This repeated scanning allows for an effective scan of a larger area of land.

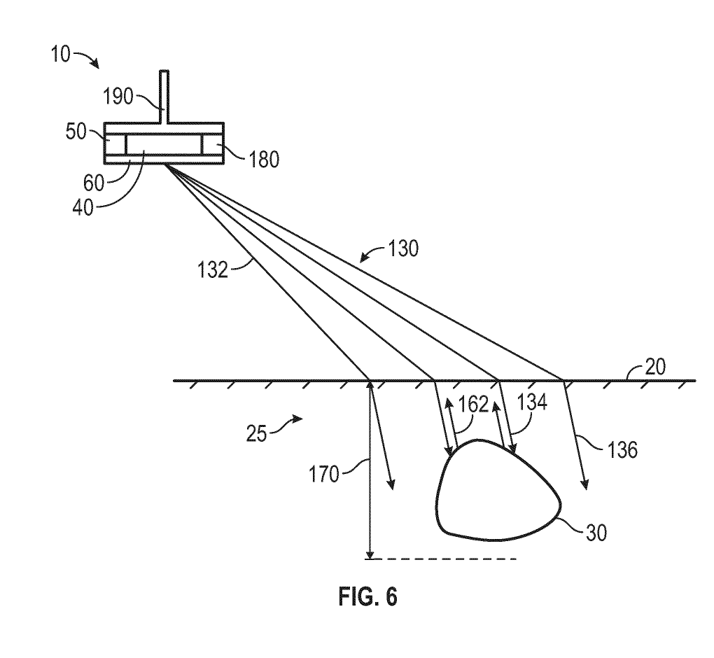

Referring next to the exemplary embodiment shown in FIG. 6, waves 132 within emitted beam 130 may travel through base level 20. Waves 132 having traveled through base level 20 may include contacting waves 134 that interact with target material 30 and errant waves 136 that do not interact with target material 30. As discussed above, contacting waves 134 interact with target material 30 and may produce contacting scattered waves 162 having a decreased energy relative to contacting waves 134. Contacting waves 134 and errant waves 136 lose energy as they travel through subterranean ground volume 25. As shown in FIG. 6, contacting waves 134 and errant waves 136 may travel down to a working distance, shown as distance 170. Distance 170 is a maximum penetration distance for mineral prospector 10 because the remaining energy of a scattered wave may be insufficient to travel back through subterranean ground volume 25.

Referring still to the exemplary embodiment shown in FIG. 6, target material 30 located at a depth below distance 170 from base level 20 may not be identified by mineral prospector 10. According to an exemplary embodiment, mineral prospector 10 may include different values of distance 170, each corresponding to one of the various tasks performed by mineral prospector 10. By way of example, mineral prospector 10 may be capable of locating or identifying target material 30 at different maximum depths. According to an exemplary embodiment, distance 170 may reach ten meters in subterranean ground volume 25 that includes conductive materials. According to an alternative embodiment, distance 170 may reach between twenty and thirty meters in subterranean ground volume 25 that includes a silica material (e.g., sand, quartz, etc.).

Referring still to the exemplary embodiment shown in FIG. 6, various factors of mineral prospector 10 and subterranean ground volume 25 may affect distance 170. As discussed above, transceiver 60 transmits emitted beam 130 that interacts with subterranean ground volume 25. Emitted beam 130 includes a plurality of waves 132 having a specified frequency. According to an exemplary embodiment, the frequency of waves 132 may affect distance 170. According to an alternative embodiment, the intensity of emitted beam 130 may affect distance 170 because waves 132 having a lower initial intensity may possess less total energy. This lower amount of energy may be lost to subterranean ground volume 25 over a shallower distance 170 than a larger total amount of energy for the same subterranean ground deposit.

Referring again to the exemplary embodiment shown in FIG. 2, the conductivities of base level 20, aggregate 70, and earth 80 within subterranean ground volume 25 may affect distance 170. Contacting wave 134 and errant wave 136 electromagnetically interact with base level 20, aggregate 70, and earth 80 as they travel downward. The electrical conductivity of base level 20, aggregate 70, and earth 80 influences the extent that base level 20, aggregate 70, and earth 80 affects the intensity or other feature of contacting wave 134 and errant wave 136. The electrical conductivity of base level 20, aggregate 70, and earth 80 may vary widely depending on a variety of factors. By way of example, the conductivity of base level 20, aggregate 70, and earth 80 may vary based on salt content, water content, the presence of carbon films, and the degree of cracking or microcracking, among other factors. Such features of base level 20, aggregate 70, and earth 80 may change regularly (e.g., each season, month, day, etc.) and require an adjustment of emitted beam 130 by mineral prospector 10 (e.g., increased intensity, lowered frequency, etc.).

According to the exemplary embodiment shown in FIGS. 3-4, emitted beam 130 includes waves 132 having a specified frequency profile. According to an exemplary embodiment, the frequency profile of each wave 132 within emitted beam 130 is uniform along range direction 62 and azimuth direction 64. Such uniform waves 132 may each include a single frequency. By way of example, the uniform frequency may be a low frequency (e.g., 1 MHz, 10 MHz, etc.) or a high frequency (e.g., 1 GHz, 10 GHz, etc.). According to the exemplary embodiment shown in FIG. 3, waves 132 may have a frequency of approximately 1 MHz and provide distance 170 of approximately ten meters. According to an alternative embodiment, waves 132 may have a frequency of approximately 1 GHz and provide distance 170 of approximately six meters.

According to an alternative embodiment, the frequency profile of each wave 132 within emitted beam 130 is non-uniform. Such non-uniform frequency profile may occur by each wave 132 having a single, specified frequency that varies along the range direction or each wave 132 having a plurality of frequencies arranged in a varying frequency bandwidth, among other potential variations of frequency among waves 132 within emitted beam 130. According to an exemplary embodiment, waves 132 proximate to inner beam limit 142 have a lower frequency than waves 132 proximate to outer beam limit 144. Varying the frequency of waves 132 across emitted beam 130 allows mineral prospector 10 to distinguish between the reflected waves within scattered beam 160 more accurately thereby improving the signal coherence of mineral prospector 10 (i.e. the ability of mineral prospector 10 to identify a particular wave 132 from others released by transceiver 60 and associate that wave with a received scattered wave using various features).

According to an alternative embodiment, each wave 132 may include a plurality of subwaves having subwave frequencies. The plurality of subwaves may include at least one subwave having a different subwave frequency than the frequency of the remaining waves 132 within emitted beam 130 thereby forming a subwave frequency gradient. Such subwave frequency gradient may take various forms. According to an exemplary embodiment, the frequency of subwaves within wave 132 varies according to an identified bandwidth having a center frequency, an upper band frequency, and a lower band frequency. In some embodiments, the subwaves of wave 132 has at least one of a variable center frequency and a variable bandwidth. A frequency bandwidth further allows for discrimination among waves 132 within emitted beam 130 (i.e., improves signal coherence) and improves the ability of mineral prospector 10 to identify target material 30 actively. The range of frequencies between the upper band frequency and the lower band frequency form a specified bandwidth. By way of example, wave 132 may have subwaves that include a center subwave frequency in the range of at least one of less than 1 MHz, 1-10 MHz, 10-100 MHz, and 100-1000 MHz and a bandwidth to center frequency ratio of between 2:1 and 10:1. By way of another example, wave 132 may have subwaves that have a fractional bandwidth of greater than 0.1. In some embodiments, wave 132 has subwaves that have a fractional bandwidth of greater than 1.

According to an alternative embodiment, the frequency of waves 132 may vary temporally where emitted beam 130 is released as a plurality of bursts. A frequency profile may occur by varying the frequency of all waves 132 uniformly between each burst of an emitted beam (i.e., sending a first burst at a first frequency and a second burst at a second frequency). Using a single frequency within each burst may provide at least the benefit of simplifying the wave production of propagator 50. According to an alternative embodiment, the frequency of waves 132 varies directionally and temporally. Such variation may occur by increasing the frequency of waves 132 within each burst and increasing the frequency of waves 132 with distance from propagator 50 along range direction 62 or azimuth direction 64. According to an alternative embodiment, the frequency of waves 132 decreases with distance along range direction 62. According to various alternative embodiments, the frequency of waves 132 varies according to a relative angle with respect to propagator 50, distance along azimuth direction 64, elevation, or another specified pattern. While the preceding paragraphs describe a specified frequency profile according to an exemplary embodiment, it should be understood that other properties of waves 132 (e.g., intensity, polarization, etc.) may vary according to similar profiles.

According to the exemplary embodiment shown in FIG. 5, wave 132 released by transceiver 60 may include a plurality of specified release characteristics. Specifying release characteristics enhances the signal coherence of mineral prospector 10 by providing additional distinguishing features that aid mineral prospector 10 in identifying each specific wave 132 released by transceiver 60. Tracking each wave 132 enhances the signal coherence of mineral prospector 10 because each wave 132 may be associated with a corresponding contacting scattered wave 162 within scattered beam 160. According to an exemplary embodiment, the specified release characteristics may include a release angle with respect to a vertical line. By way of example, a release angle of wave 132 corresponds to a specific distance in the range direction and an equal incident angle for contacting scattered wave 162. Mineral prospector 10 may then associate a particular received contacting scattered wave 162 with a particular location given a specified height of transceiver 60. According to various alternative embodiments, the specified release characteristics may include release angle with respect to the range dimension, and other features of emitted beam 130.

Referring next to FIGS. 3-8, waves 132 may include a wave shape. According to the exemplary embodiment shown in FIG. 3, the wave shape of waves 132 may be created by propagator 50 and designed to maximize a performance characteristic of mineral prospector 10 (e.g., penetration distance, resolution, accuracy, signal coherence, etc.). The wave shape of waves 132 may be uniform within emitted beam 130 or may vary along range direction 62, azimuth direction 64, or temporally, among other known dimensions. As shown in FIG. 5, waves 132 having a specified wave shape are scattered by base level 20 or target material 30 and produce contacting scattered wave 162, surface back scattered wave 164, and surface side scattered wave 166 having the specified wave shape. As discussed above, transceiver 60 may receive scattered beam 160 having the specified wave shapes. Including various wave shapes may allow mineral prospector 10 to further differentiate between waves 132 within emitted beam 130 thereby improving the signal coherence of mineral prospector 10.

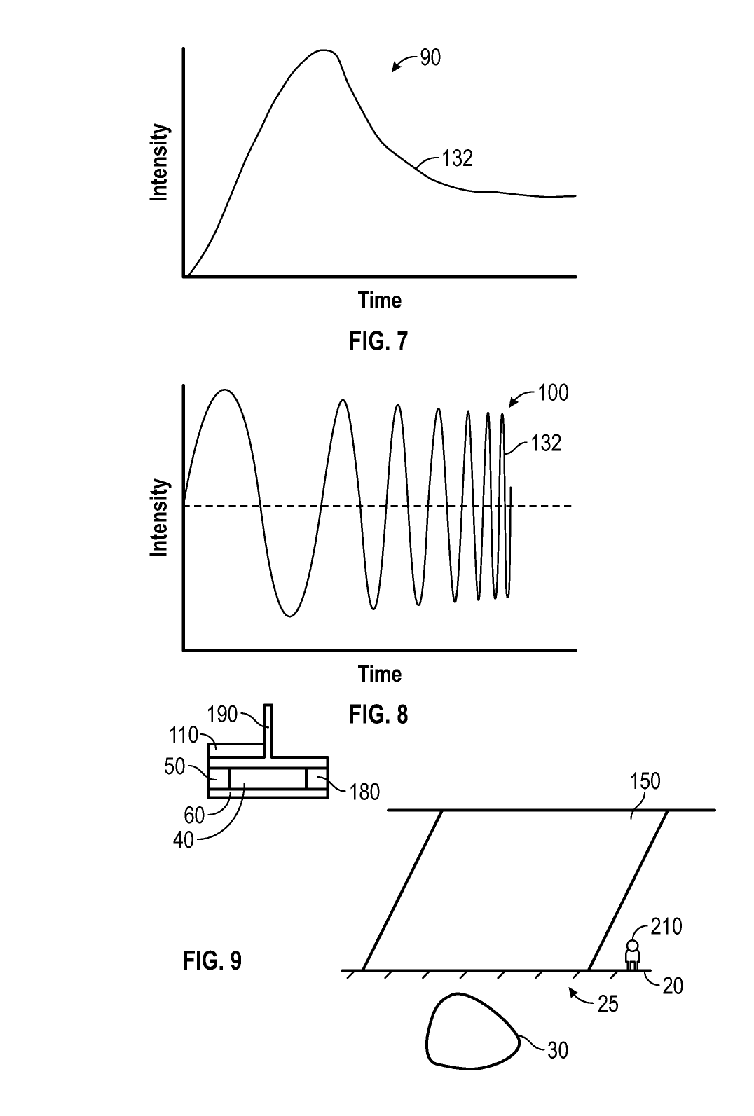

According to the exemplary embodiment shown in FIGS. 7-8, waves 132 may have a specified wave form. As shown in FIG. 7, waves 132 may have first wave form 90. First wave form 90 comprises an electromagnetic energy curve that first increases and then decreases with respect to time. While a specific pattern of increasing and decreasing intensity is shown in FIG. 7, an ordinary artisan in the relevant art will understand that various patterns of intensity are possible. According to the exemplary embodiment shown in FIG. 8, waves 132 may have second wave form 100. As shown in FIG. 8, second wave form 100 may include a continuous wave having a frequency that increases with respect to time. As shown in FIG. 3, the profile of the increase in frequency may be varied to increase or decrease distance 170 or as needed to most efficiently identify target material 30. According to an alternative embodiment, second wave form 100 may include a multiple chirp design. Such a multiple chirp design may include a plurality of wave forms each having a frequency that increases over time. According to still another alternative embodiment, second wave from 100 may include a stepped frequency continuous wave form having a frequency that may increase with respect to time at several identified steps.

According to an exemplary embodiment shown in FIG. 3, waves 132 within emitted beam 130 include a specified linear polarization. According to an exemplary embodiment, the specified linear polarization of waves 132 within emitted beam 130 may be a single, uniform polarization. Such polarization may be vertical, horizontal, or at an angle to a vertical polarization axis. In other embodiments, the polarization of waves 132 within emitted beam 130 may be a dual-polarization or a quad-polarization. According to various alternative embodiments, waves 132 within emitted beam 130 may include a linear polarization having two polarization directions, a linear polarization having more than two polarization directions, or a circular polarization, among other known variations of polarization for electromagnetic waves. According to still another alternative embodiment, the polarization of waves 132 may vary along range direction 62, azimuth direction 64, or according to another known dimension.

According to the exemplary embodiment shown in FIG. 3, mineral prospector 10 may identify target material 30 using various techniques that employ distinguishing characteristics of target. As discussed above, emitted beam 130 interacts with target material 30 and reflects back towards transceiver 60 as scattered beam 160. Various target materials 30 may interact with emitted beam 130 differently. This interaction may produce scattered beam 160 having distinguishing characteristics based on the identity (i.e. composition, make-up, constituent materials, etc.) of target material 30. By way of example, emitted beam 130 having various patterns of reflectivity, frequency, multiple wavebands, polarization, intensity, variations of these features with a changing angle, etc. interact with gold to produce scattered beam 160 having a unique reflectivity, frequency, waveband, polarization, intensity, or variation of these features with a changing angle, etc.

Referring still to the exemplary embodiment shown in FIG. 3, variation of intensity with respect to the angle of waves 132 may be a distinguishing characteristic of a gold deposit having a flake structure. Such a flake structure may produce scattered beam 160 having an increased intensity over a certain range of angles that fades across other angles because of the orientation of the gold flakes. Target materials 30 may include further distinguishing characteristics including a characteristic structure thickness. These distinguishable characteristics may vary according to the type, quantity, and depth of target material 30. Scattered beam 160 having a random orientation of distinguishable features may require additional processing. By way of example, random scattering may occur within metallic gold particles having a diameter approximately equal to the wavelength of emitted beam 130. Such random scattering may require the Mie solution to gain information from scattered radiation.

Referring next to the exemplary embodiment shown in FIG. 9, mineral prospector 10 may further include a signal coherence augmentation system, shown as booster 110. Booster 110 is configured to improve the signal coherence of mineral prospector 10 by reducing the errors introduced by at least one limiting factor. Such limiting factors may include determining the position of transceiver 60, quantifying the time between when propagator sends emitted beam 130 to the time transceiver 60 receives scattered beam 160, and the azimuthal accuracy, among other factors that may introduce error.

According to an exemplary embodiment, booster 110 is a global positioning system capable of determining the location and timing of at least one of propagator 50 and transceiver 60. Booster 110 may be coupled to support 40 proximate to at least one of propagator 50 and transceiver 60 or may be mounted apart from the other components of mineral prospector 10. According to an exemplary embodiment, booster 110 tracks the movement at least one of propagator 50 and transceiver 60. Tracking may be possible by booster 110 determining the position of at least one of propagator 50 and transceiver 60 at various times and incorporating the plurality of position measurements together to form a recorded path. Such movement may be recorded independently within booster 110, transmitted to a remote location, or transmitted to another component within mineral prospector 10 for further processing. According to an alternative embodiment, booster 110 associates a time with the position of at least one of the propagator 50 and transceiver 60. Such timing information allows booster 110 to provide both spatial and timing data and may increase the signal coherence of mineral prospector 10. According to an exemplary embodiment, booster 110 utilizes an augmented global positioning system (e.g., differential global positioning system, wide area augmentation system, etc.) to further enhance the signal coherence of mineral prospector 10.

Referring again to the exemplary embodiment shown in FIG. 5, mineral prospector 10 may be interfaced with carrier 190 to reduce Doppler shift associated with scattered beam 160. Doppler shift describes a change in the phase of contacting scattered wave 162, surface back scattered wave 164, and surface side scattered wave 166 with respect to the phase of waves 132. Compensating for Doppler shift involves readjusting the phase of waves within scattered beam 160. Such compensation improves the signal coherence of mineral prospector 10 and requires a measurement of the relative velocity of carrier 190 with respect to base level 20. Computing the velocity of carrier 190 may be accomplished according to various known means (e.g., airspeed measurement, physical measurement, global positioning system, etc.). According to the exemplary embodiment shown in FIG. 9, mineral prospector 10 may be configured to interact with a signal indicating the velocity of carrier 190 from booster 110. According to various alternative embodiments, mineral prospector 10 may be configured to interact with a velocity signal received from carrier 190 or obtained by another suitable means.

Referring to FIG. 4, Doppler shift may occur even among waves within scattered beam 160. As shown in FIG. 4, carrier 190 may move relative to base level 20 at a velocity as discussed above. According to an exemplary embodiment, inner beam limit 142 is located closer to carrier 190 than outer beam limit 144 along range direction 62. This distance between inner beam limit 142 and outer beam limit 144 results in a different relative velocity of carrier 190 with respect to inner beam limit 142 and carrier 190 with respect to outer beam limit 144. The difference in relative velocities may cause a Doppler shift between the scattered beam 160 reflected from portions of swath 140 that are further from carrier 190. According to an exemplary embodiment, mineral prospector 10 may adjust the phase of phase-shifted waves within scattered beam 160 to further improve the signal coherence of mineral prospector 10. For mineral prospector 10 to compensate for Doppler shifted waves, mineral prospector 10 may interface with the velocity of carrier 190 according to a method disclosed above. As discussed above, transceiver 60 is configured to receive contacting scattered waves 162, surface back scattered waves 164, and surface side scattered waves 166.

Referring again to the exemplary embodiment shown in FIG. 9, an operator, shown as user 210 may interact with at least one of carrier 190 and mineral prospector 10. According to an exemplary embodiment, user 210 may monitor the various components of mineral prospector 10. By way of example, such monitoring may include evaluating whether transceiver 60 is receiving scattered beam 160 and determining whether mineral prospector 10 indicates the presence of target material 30. According to an alternative embodiment, user 210 may direct the motion of carrier 190. By way of example, such directing may include steering carrier 190 to ensure that swath 140 passes over prospecting zone 150, directing carrier 190 along a specified path, performing maintenance on various components of mineral prospector 10, and operating at least one of propagator 50 and transceiver 60, among other operations.

According to the exemplary embodiment shown in FIG. 9, user 210 may be located remotely from carrier 190. By way of example, user 210 may be in radio communication with carrier 190 using radio waves at a specified frequency. Remote operation of carrier 190 by user 210 may allow user 210 to remain in a safe location while allowing carrier 190 to scan prospecting zone 150. By way of example, carrier 190 may be operating in a hostile environment (e.g., due to heat, humidity, elevation, combat, etc.) and remote operation of carrier 190 by user 210 may allow user 210 to remain outside the hostile environment. According to an alternative embodiment, user 210 maintains long-range communication with carrier 190. By way of example, long-range communication may include satellite communication, Ethernet network communication, and various other known techniques capable of transmitting information over a long distance. Such long-range communication may still further separate user 210 from a hostile operating environment of mineral prospector 10.

According to an alternative embodiment, user 210 may be located proximate to carrier 190 (e.g., onboard, within, above, on, etc.). User 210 located proximate to carrier 190 may visually inspect the various components of carrier 190 and mineral prospector 10 for a condition (e.g., wear, damage, operation condition, etc.) and promote the efficient and continuous operation mineral prospector 10. According to an alternative embodiment, user 210 may operate at least one of carrier 190, propagator 50, and transceiver 60 from carrier 190. Onboard operation of carrier 190 may allow user 210 to obtain surrounding information and adapt the operation of carrier 190 or mineral prospector 10 accordingly. Such surrounding information may include surface characteristics of prospecting zone 150, weather conditions, and potential movements that could affect the signal coherence of mineral prospector 10, among other conditions of surfaces or environments surrounding carrier 190.

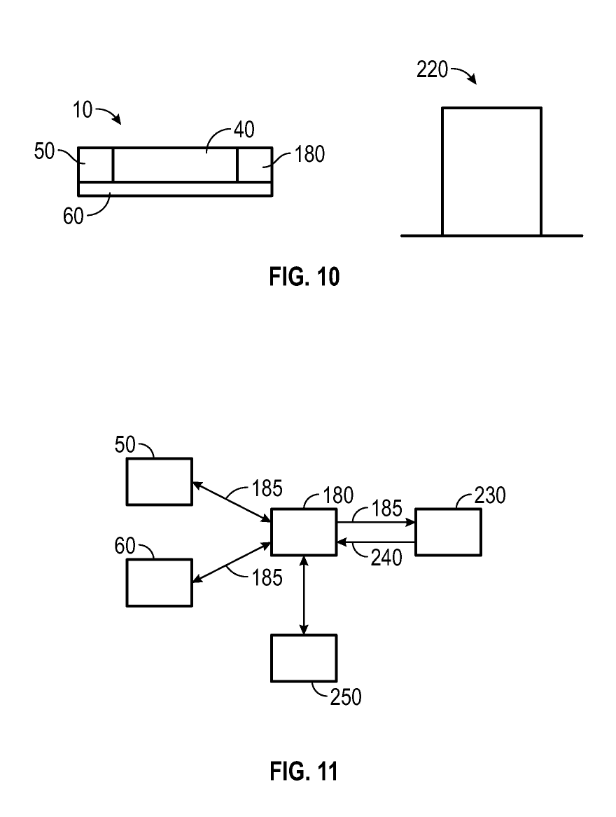

According to the exemplary embodiment shown in FIG. 10, mineral prospector 10 may further include a data management system, shown as analyzer 180. According to an exemplary embodiment, analyzer 180 utilizes coherent aperture synthesis to process various characteristics emitted and received electromagnetic waves (e.g., a plurality of radar returns, etc.). Such coherent aperture synthesis may rely on a horizon to horizon aperture technique to accomplish the exploration process of mineral prospector 10.

According to the exemplary embodiment shown in FIG. 10, analyzer 180 may identify a deposit by relying on previously collected characteristic signatures. Such previously collected characteristic signatures may be obtained by operating mineral prospector 10 over a known deposit and analyzing the spatial structure; reflectivity; variation of reflectivity with angle, polarization, or wavelength; variation frequency; variation of frequency with angle, polarization, wavelength, waveband, and intensity; and other features of emitted and scattered beams. Such features of emitted and scattered beams may result from interaction between the emitted beams and a target material or a surrounding material. According to an exemplary embodiment, analyzer 180 may then compare information gathered from the distinguishable features of the emitted and scattered beams with the previously collected characteristic signature. Analyzer 180 may then return an identification signal if the distinguishable features of the emitted and scattered beams are approximately equal to the previously collected characteristic signature.

According to an alternative embodiment, mineral prospector 10 may locate a target material using a conductivity differences between the target material and surrounding earth. Scattered beams that interact with a target material may include different properties than scattered beams that did not interact with a target material and produce scattered beams having distinguishable features. By way of example, emitted beams having various patterns of reflectivity, frequency, multiple wavebands, polarization, intensity, variations of these features with a changing angle, etc. may interact with gold to produce scattered beams having a unique reflectivity frequency, waveband, polarization, and intensity, or variations of these features with a changing angle, etc. than scattered beams that did not interact with gold and instead interacted only with earth. Analyzer 180 may then compare these characteristics of various scattered beams to find differences among the scattered beams. These differences may allow analyzer 180 to locate a target material.

According to an alternative embodiment, analyzer 180 may identify or locate a target material by relying on a characteristic signature generated using known electromagnetic properties of the target material. Relying on a theoretically constructed characteristic signature may be advantageous for at least the reason of reducing cost by eliminating the necessary step of acquiring sufficient data to construct an experimental characteristic signature. By way of example, a target material may have a known conductance greater than the surrounding earth. A characteristic signature may be generated using the ratio of conductance of the target material to the surrounding earth. Mineral prospector 10 may then identify or locate the target material by comparing the observed ratio between the conductance of a prospective target material to the conductance of the surrounding earth with a theoretical ratio between the conductance of the target material to the conductance of the surrounding earth.

According to an exemplary embodiment shown in FIG. 10, mineral prospector 10 may spatially locate a target material in one dimension. Such one-dimensional identification may take the form of a locator point. A locator point is preferable for at least the reason that it may require less computational power to identify than a two- or three-dimensional model. By way of example, analyzer 180 may generate the locator point by determining the location of each scattered wave within a scattered beam and evaluating the reflectivity of the corresponding point. The locator point may be the position where the reflectivity is greatest. Mineral prospector 10 may then indicate this position as the locator point.

According to an alternative embodiment, mineral prospector 10 may locate a target material in two dimensions. Mineral prospector 10 may produce a two-dimensional location as a flat planar surface. To generate the two-dimensional surface, analyzer 180 may examine characteristics of scattered beams discussed above to determine which waves within the scattered beams interacted with the target material. The outlying locations where analyzer 180 determines waves within the scattered beams did not interact with the target material may form the edge of the planar surface locating target material 30.

According to an alternative embodiment, mineral prospector 10 may locate a target material in three dimensions. Scattered beams having interacted with a target material may have different characteristics than scattered beams that did not interact with a target material. Such a three dimensional location may be limited only by the object contrast and the number of photons detected. As such, the use of high power and long integration times may be needed to ensure an appropriately high resolution. Scattered radiation having interacted with a thicker layer of a target material may have different characteristics than scattered beams having interacted with a thinner layer of a target material. Differentiation between scattered beams that interacted with a thicker layer of a target material and scattered beams that interacted with a thinner layer of a target material allows analyzer 180 to produce a depth sensitive location of a target material. This third dimension of depth may allow for three-dimensional imaging of a target material with a specified sub-wavelength resolution.

According to the exemplary embodiment shown in FIG. 10, analyzer 180 may employ a resolution enhancing technique to further improve the signal coherence and precision of mineral prospector 10. Such resolution enhancing techniques may include successive approximation, back projection, superresolution, or another known technique. Analyzer 180 employing a resolution enhancing technique may achieve a greater three-dimensional resolution in the presence of surrounding media of unknown electromagnetic properties.

According to the exemplary embodiment shown in FIGS. 10-11, analyzer 180 may provide information about target material to another device. As shown in FIGS. 10-11, analyzer 180 may be coupled to transceiver 60. According to an exemplary embodiment, analyzer 180 may receive characteristic 185 from transceiver 60 or propagator 50 (e.g., angle relative to a vertical line, polarity, wavelength, intensity, the time the transceiver 60 emitted the wave, the time transceiver 60 received the scattered wave, etc.). As shown in FIG. 10, analyzer 180 may provide the characteristic to a storage area, shown as data repository 220.

According to the exemplary embodiment shown in FIG. 11, analyzer 180 may further include logic element 230. Logic element 230 may receive characteristic 185 from analyzer 180, execute a program to determine the presence, identity, nature, or location, among other features, of a target material deposit disposed within an underground volume. Such program may compare a sample value with a previously obtained or theoretically derived reference value of reflectivity, spatial structure, and variation in reflectivity with a changing angle, among other electromagnetic properties of a target material deposit, as discussed above. Analyzer 180, logic element 230, and related elements having a computational function use a processing circuit (e.g., processor, memory, computer readable instructions, etc.) to execute the computational function.

According to an exemplary embodiment, logic element 230 may associate such presence, identity, nature, or location of a target material deposit with indicator signal 240 as a one dimensional point source identifier, a volume identifier, a series of points forming a two dimensional plane and, a series of points forming a three dimensional surface, among other known configurations. Logic element 230 may then provide indicator signal 240 to analyzer 180. According to the exemplary embodiment shown in FIG. 11, analyzer 180 may transmit indicator signal 240 to an interface (e.g., LED, LCD, etc.) as a one, two, or three dimensional representation of indicator signal 240. According to an alternative embodiment, analyzer 180 may transmit indicator signal 240 to a data storage system as a one-, two-, or three-dimensional representation of indicator signal 240.

According to an exemplary embodiment, mineral prospector 10 is configured to coherently process the plurality of radar returns to form an image including a target material deposit. The image may include a two-dimensional or a three-dimensional image. The image may include a spatial representation of the target material deposit. Mineral prospector 10 may convert or transform coherent phase information received by the radar to create a spatial representation of some form. In some embodiments, the image includes coherently processed radar data that does not include a correction for subsurface electromagnetic force (emf) properties (i.e., an uncorrected plot of reflected intensity associated with the plurality of radar returns, etc.).

According to another exemplary embodiment, mineral prospector 10 is configured to coherently process the plurality of radar returns to form a model including a target material deposit. The model may include a two-dimensional or a three-dimensional model. In one embodiment, the model includes a plot that is corrected for surface and subsurface index effects (e.g., dielectric properties, refractive index effects, etc.) and/or based on a composition of the underground volume. The index effects may be assumed dielectric properties, measured dielectric properties (e.g., radar measured, measure by drilling a hole and taking a sample, etc.), or iteratively estimated dielectric properties (e.g., autofocus, etc.). The model may be created by performing a plurality of passes of the underground volume to improve the clarity of the model and the determinations of what the mediums (e.g., materials, etc.) the waves are propagating through are composed of (e.g., self-consistent modeling, etc.).

According to yet another exemplary embodiment, mineral prospector 10 is configured to coherently process the plurality of radar returns to form a feature map including a feature (e.g., a target material deposit, etc.) disposed within an underground volume. The feature map may include a two-dimensional or a three-dimensional map. In one embodiment, the feature map includes at least one of a location and a nature of the feature disposed within the underground volume. The feature disposed within the underground volume may include at least one of a glint and a boundary between regions having different dielectric constants (e.g., electrical conductivity, magnetic conductivity, etc.).

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner. Accordingly, all such modifications are intended to be included within the scope of the present inventions. The order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes, and omissions may be made in the design, operating conditions, and arrangement of the preferred and other exemplary embodiments without departing from scope of the present disclosure or from the spirit of the appended claims.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data that cause a general purpose computer, special purpose computer, or special purpose processing machines to perform a certain function or group of functions.

Although the figures may show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1-94. (canceled)

95. A system for detecting underground natural resources using synthetic aperture radar, the system comprising:
a ground-penetrating phase-coherent radar system including:
a transmitter configured to send a plurality of radar signals from a plurality of points along a plurality of paths through an underground volume, the plurality of radar signals producing a plurality of radar returns;
a receiver configured to engage the plurality of radar returns; and
a moving platform, wherein the ground-penetrating phase-coherent radar system is configured to collect the plurality of radar returns along the plurality of paths; and
a processing circuit including a memory and coupled to the ground-penetrating phase-coherent radar system, wherein the processing circuit is configured to:
coherently process the plurality of radar returns to determine a characteristic of a sub-surface feature;
retrieve information relating to a reference underground volume from the memory; and
identify a potential sub-surface resource by comparing the characteristic of the sub-surface feature with the reference underground volume.

96. The system of claim 95, wherein the processing circuit is configured to form an image comprising a two-dimensional image or a three-dimensional image.

97. The system of claim 96, wherein the image comprises coherently processed radar data without correction for subsurface emf properties including a plot of reflected intensity associated with the plurality of radar returns.

98. The system of claim 95, wherein the processing circuit is configured to form a model comprising a two-dimensional model or a three-dimensional model.

99. The system of claim 98, wherein the model comprises a plot that is corrected for surface and subsurface index effects.

100. The system of claim 99, wherein the processing circuit is configured to generate the plot based on a composition of the underground volume.

101. The system of claim 95, wherein the processing circuit is configured to form a feature map comprising a two-dimensional map or a three-dimensional map.

102. The system of claim 101, wherein the feature map comprises a plot including at least one of a location and a nature of a feature disposed within the underground volume.

103. The system of claim 102, wherein the feature disposed within the underground volume includes at least one of a glint and a boundary between regions having different dielectric constants.

104. The system of claim 95, wherein the characteristic of the sub-surface feature includes at least one of reflectivity, a variation in reflectivity with angle, a variation in reflectivity with polarization, a variation in reflectivity with polarization and angle, a variation in reflectivity with wavelength, a spatial structure, and an electromagnetic property of the sub-surface feature.

105-112. (canceled)

113. The system of claim 95, wherein the processing circuit is configured to determine a property of the potential sub-surface resource.

114. The system of claim 113, wherein the property includes a composition of the potential sub-surface resource.

115. The system of claim 95, wherein the ground-penetrating phase-coherent radar system comprises a monostatic system including a transmitter and a receiver that are co-located on the moving platform.

116. The system of claim 95, wherein the ground-penetrating phase-coherent radar system comprises a bistatic system including a transmitter and a receiver that are spaced apart.

117. The system of claim 116, wherein one of the transmitter and the receiver are positioned on the moving platform.

118. The system of claim 95, wherein the ground-penetrating phase-coherent radar system comprises a multistatic system including a first transmitter, a first receiver, and at least one of a second transmitter and a second receiver.

119. The system of claim 118, wherein one of the first transmitter and the first receiver are positioned on the moving platform.

120-129. (canceled)

130. A system for detecting underground natural resources using synthetic aperture radar, the system comprising:
a ground-penetrating phase-coherent radar system including:
a transmitter configured to send a plurality of radar signals from a plurality of points along a plurality of paths through an underground volume, the plurality of radar signals producing a plurality of radar returns;
a receiver configured to engage the plurality of radar returns; and
a moving platform, wherein the ground-penetrating phase-coherent radar system is configured to collect the plurality of radar returns along the plurality of paths; and
a processing circuit including a memory and coupled to the ground-penetrating phase-coherent radar system, wherein the processing circuit is configured to:
coherently process the plurality of radar returns to produce data relating to a characteristic of a sub-surface feature;
retrieve a database of values relating to sub-surface resources from the memory; and
identify a potential sub-surface resource by comparing the data relating to the characteristic of the sub-surface feature with the database of values.

131. The system of claim 130, wherein the characteristic of the sub-surface feature includes at least one of reflectivity, a variation in reflectivity with angle, a variation in reflectivity with polarization, a variation in reflectivity with polarization and angle, a variation in reflectivity with wavelength, a spatial structure, and an electromagnetic property of the sub-surface feature.

132-139. (canceled)

140. The system of claim 130, wherein the processing circuit is configured to determine a property of the potential sub-surface resource.

141. The system of claim 140, wherein the property includes a composition of the potential sub-surface resource.

142. The system of claim 130, wherein the ground-penetrating phase-coherent radar system comprises a monostatic system including a transmitter and a receiver that are co-located on the moving platform.

143. The system of claim 130, wherein the ground-penetrating phase-coherent radar system comprises a bistatic system including a transmitter and a receiver that are spaced apart.

144. The system of claim 143, wherein one of the transmitter and the receiver are positioned on the moving platform.

145. The system of claim 130, wherein the ground-penetrating phase-coherent radar system comprises a multistatic system including a first transmitter, a first receiver, and at least one of a second transmitter and a second receiver.

146. The system of claim 145, wherein one of the first transmitter and the first receiver are positioned on the moving platform.

147-156. (canceled)

157. A system for experimentally generating a reference associated with underground natural resources, the system comprising:
a ground-penetrating phase-coherent radar system including:
a transmitter configured to send a plurality of radar signals from a plurality of points along a plurality of paths through an underground volume containing a known sub-surface resource, the plurality of radar signals producing a plurality of radar returns;
a receiver configured to engage the plurality of radar returns; and
a moving platform, wherein the ground-penetrating phase-coherent radar system is configured to collect the plurality of radar returns along the plurality of paths; and
a processing circuit coupled to the ground-penetrating phase-coherent radar system and configured to:
coherently process the plurality of radar returns to produce processed data values; and
generate at least one of a reference underground volume and a database of the processed data values relating an identity of the known sub-surface resource with a characteristic of the known sub-surface resource.

158. The system of claim 157, wherein the database relates the characteristic of the known sub-surface resource with a composition of the known sub-surface resource.

159. The system of claim 158, wherein the processing circuit is configured to coherently process the plurality of radar returns using known electromagnetic properties of the known sub-surface resource.

160. The system of claim 157, wherein the characteristic of the known sub-surface resource includes at least one of reflectivity, a variation in reflectivity with angle, a variation in reflectivity with polarization, a variation in reflectivity with polarization and angle, a variation in reflectivity with wavelength, a spatial structure, and an electromagnetic property of the known sub-surface resource.

161-167. (canceled)

168. The system of claim 157, wherein the ground-penetrating phase-coherent radar system comprises a monostatic system including a transmitter and a receiver that are co-located on the moving platform.

169. The system of claim 157, wherein the ground-penetrating phase-coherent radar system comprises a bistatic system including a transmitter and a receiver that are spaced apart.

170. The system of claim 169, wherein one of the transmitter and the receiver are positioned on the moving platform.

171. The system of claim 157, wherein the ground-penetrating phase-coherent radar system comprises a multistatic system including a first transmitter, a first receiver, and at least one of a second transmitter and a second receiver.

172. The system of claim 171, wherein one of the first transmitter and the first receiver are positioned on the moving platform.

173-182. (canceled)
